(19) United States
(12) Patent Application Publication
(10) Pub. No.: US 2011/0271551 A1
(43) Pub. Date: Nov. 10, 2011

(54) FORCED HEATED AIR DRYER FOR DENTAL/MEDICAL INSTRUMENTS

(76) Inventor: Robert S. Pearce, New Milford, CT (US)

(21) Appl. No.: 13/099,935

(22) Filed: May 3, 2011

Related U.S. Application Data
(60) Provisional application No. 61/331,214, filed on May 4, 2010.

(51) Int. Cl. F26B 3/02; F26B 25/06

(52) U.S. Cl. 34/492; 34/218

(57) ABSTRACT

A forced heated air dryer for dental/medical instruments may be used to dry instruments prior to sterilization to prevent water corrosion and the discoloration of instruments. The dryer may also be used to dry damp instruments after the sterilization process to ensure the instruments and packaging are dry prior to storage. This may prevent corrosion and discoloration of instruments between usages. The dryer may allow a medical/dental office to dry their instruments in a single automated step not combined with washing, providing for an economical, efficient and safe solution to dry instruments.

### CROSS-REFERENCE TO RELATED APPLICATIONS

This application claims the benefit of priority of U.S. provisional patent application No. 61/331,214, filed May 4, 2011, the contents of which are herein incorporated by reference.

### BACKGROUND OF THE INVENTION

The present invention relates to air dryers and, more particularly, to a forced heated air dryer for dental/medical instruments for drying instruments prior and/or after the sterilization process.

The Center for Disease Control recommends the forced air drying of instruments prior to final sterilization to minimize instrument corrosion. Also, the use of automated equipment is safer and more efficient than manual or air drying of wet instruments prior to sterilization.

Dental offices typically allow instruments to air dry on countertops or they manually hand dry the instruments. Conventional products may combine washing and a drying cycle, however, such products are expensive and time consuming.

As can be seen, there is a need for an apparatus for drying medical and/or dental instruments before and/or after the sterilization process.

### SUMMARY OF THE INVENTION

In one aspect of the present invention, a box for drying instruments, comprises at least one fan adapted to move air through the box; at least one heating element adapted to warm the air moving through the box; at least one drying rack positioned inside the box for holding the instruments; and an access into an interior of the box.

In another aspect of the present invention, a method for drying medical or dental instruments comprises placing the instruments onto a drying rack in a box via an access into an interior of the box; moving air through the box by one or more fans; and heating the air moving through the box by one or more heating elements.

These and other features, aspects and advantages of the present invention will become better understood with reference to the following drawings, description and claims.

### BRIEF DESCRIPTION OF THE DRAWINGS

FIG. 1 is a perspective view of a forced heated air dryer with its cover removed for clarity, according to an exemplary embodiment of the present invention;

FIG. 2 is a perspective view of the forced heated air dryer of FIG. 1;

FIG. 3 is a right side view of the forced heated air dryer of FIG. 1;

FIG. 4 is a left side view of the forced heated air dryer of FIG. 1;

FIG. 5 is a rear side view of the forced heated air dryer of FIG. 1;

FIG. 6 is a cross-sectional view taken along line 6-6 of FIG. 2; and

FIG. 7 is an exploded view of the forced heated air dryer of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a forced heated air dryer for dental/medical instruments that may be used to dry instruments prior to sterilization to prevent water corrosion and discoloration of instruments. The dryer may also be used to dry damp instruments after the sterilization process to ensure the instruments and packaging are dry prior to storage. This may prevent corrosion and discoloration of instruments between usages. The dryer may allow a medical/dental office to dry their instruments in a single automated step not combined with washing, providing for an economical, efficient and safe solution to dry instruments.

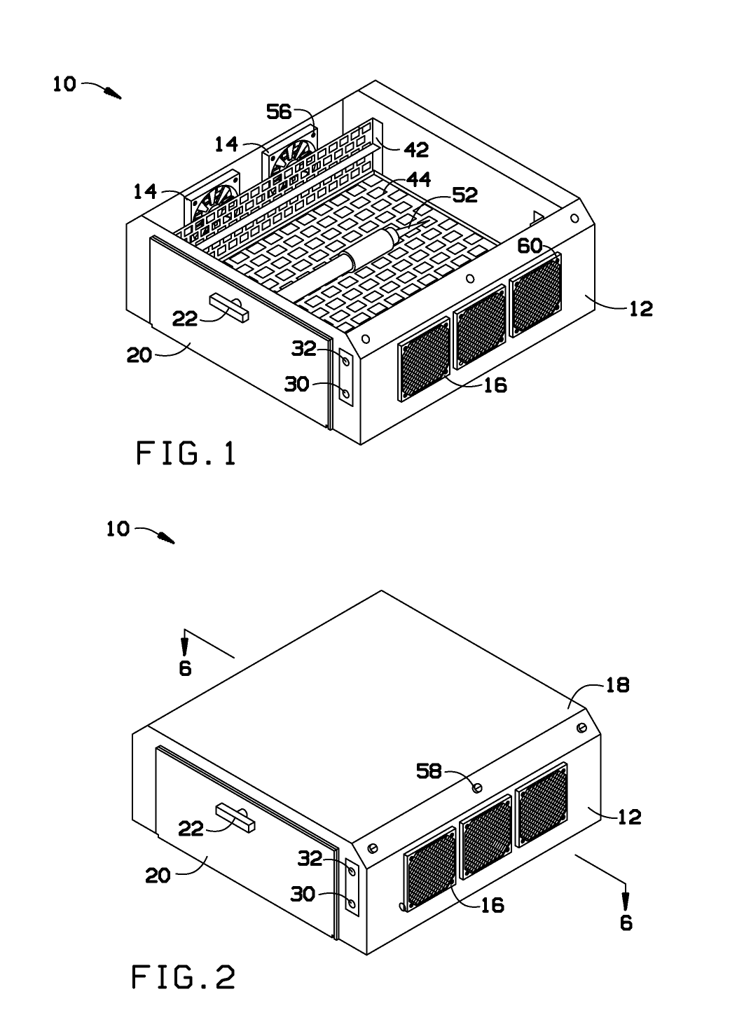

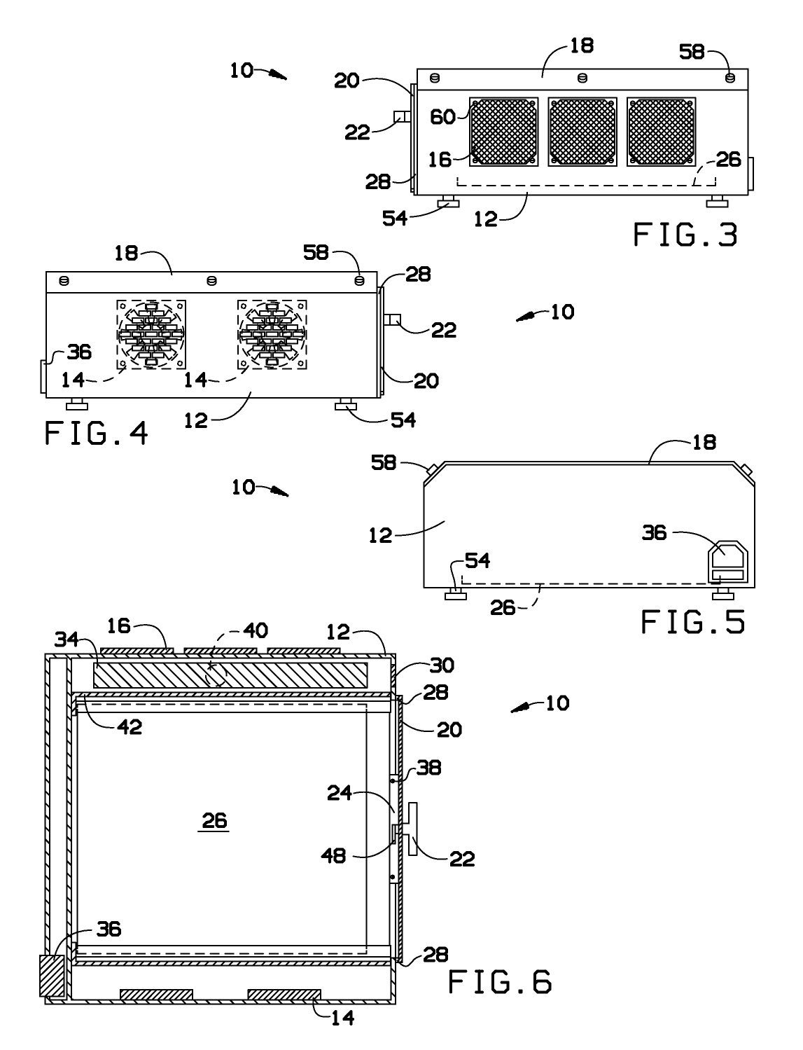

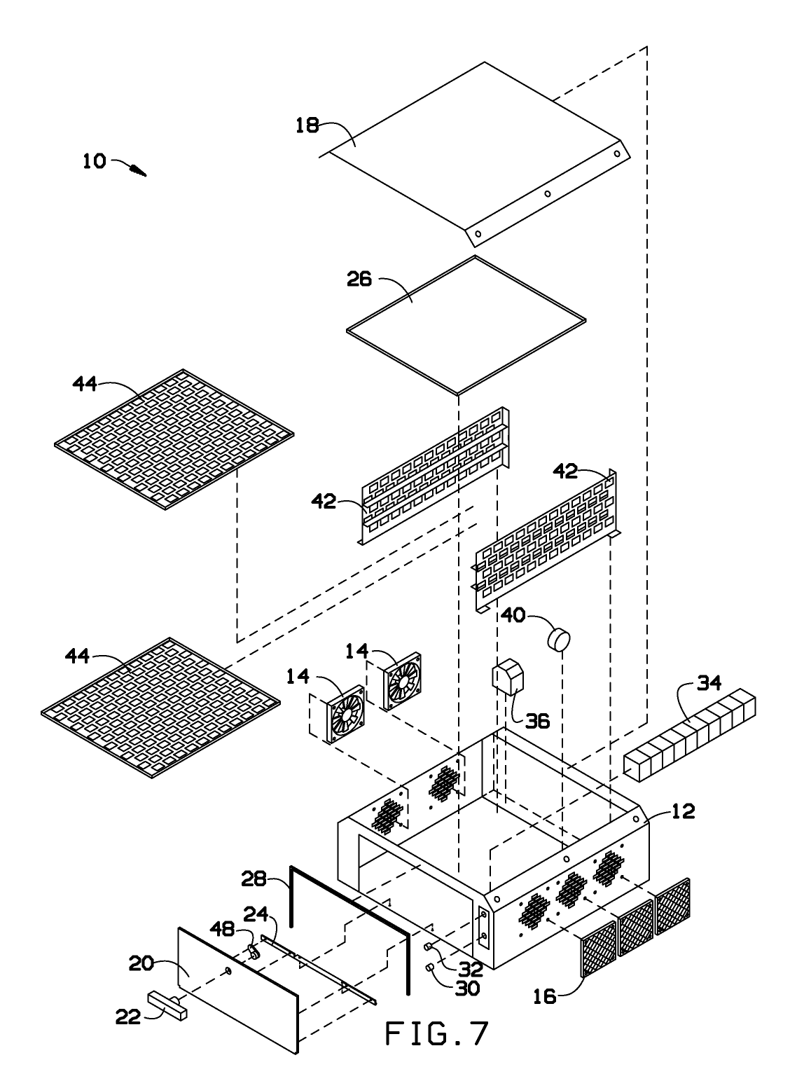

Referring to FIGS. 1 through 7, a forced heated air dryer 10 (also referred to as dryer 10) may include a box 12 and a cover 18 that may be joined together with a fastener 58, for example. The box 12 and cover 18 may be designed of, for example, a high industrial metal. The box 12 and cover 18 may be painted using, for example, a baked enamel based paint.

One or more fans 14, typically two fans, may generate forced air flow to help dry instruments 52 inside the dryer 10. The fans 14 may remain operational for an additional period of time after a heating element 34 is turned off, typically from about 1 to about 5 minutes, usually about 3 minutes, to cool the dryer 10 and instruments prior to removal. In some embodiments, the fans 14 may be disposed at air intakes to push air across the heating element 34 and through the dryer 10. In other embodiments, as shown in FIG. 1, the fans 14 may be disposed to push air out of the dryer 10, after the air has already passed over the heating element 34. The fans 14 may be attached to the box 12 with a plurality of fan screws 56.

Dust filters 16 may be disposed over an air intake to reduce dust particles from entering the dryer 10, resulting in a cleaner, dust-free drying environment. The filters 16 may be replaced periodically, for example annually. The dust filters 16 may be attached to the box with, for example, a plurality of filter screws 60.

A control board 36 may receive power and distribute power throughout the dryer 10 to the heating element 34, fans 14, and an activation light 32. The control board 36 may include a fuse (not shown) to protect the dryer 10 from surge, overload or short.

A door 20 and a door hinge 34 may be manufactured of high industrial metal and may be disposed to cover an opening of the box 12 and cover 18. A door seal 28, such as a magnetic door seal, may help contain heat and proper air flow through the dryer 10. The door hinge 34 may be attached to the box 12 and the door 20 with a plurality of hinge screws 28. A door handle 22 may be disposed on the door 20 for opening and closing the door 20. A latch 48 may be used to secure the door 20 in a closed position.

A drip pan 28 may be disposed on a bottom interior surface of the box 12 to catch water and prevent possible corrosion to the bottom of the box 12. The drip pan 28 may be removed, cleaned and manually dried when needed.

An activation button 30 may simultaneously turn on the fans 14 and heating element 34 for a complete drying cycle, typically about 20 minutes. The activation light 32 may illuminate during the cycle. At the end of a heating cycle, typically about 17 minutes, the heating element 34 may turn-off and the fans 14 may remain in operation for an additional period of time, typically about three minutes. A thermal protector may automatically turn off the unit if the temperature reaches a pre-set maximum, typically about 98 C. This safety preventative measure may be activated if the fans 14 or activation button 30 were to prematurely fail or if the intake filters 16 become clogged, or the like.

Drying pans 44 may be mounted on drying pan racks 42. The drying pan racks 42 and pans 44 may be made from steel, for example. Each drying pan rack 42 and pan 44 may be vented for optimal forced air flow within the dryer 10. The drying pan rack 42 and pan 44 may be designed to handle the weight load of instruments and/or cassettes. The drying racks 44 may be removable from the dryer 10 as needed.

A plurality of feet 54 may keep the box 12 spaced from a surface that the dryer 10 is used upon. The feet 54 may provide ventilation under the box 12 and help maintain proper temperature control within the dryer 10.

The dryer 10 may be designed as a stand-alone unit that may be movable, portable and able to be utilized in any cleaning and sterilization setup. The dryer 10 may be reconfigured and manufactured into various shapes and sizes.

It should be understood, of course, that the foregoing relates to exemplary embodiments of the invention and that modifications may be made without departing from the spirit and scope of the invention as set forth in the following claims.

What is claimed is:

1. A box for drying instruments, comprising:
at least one fan adapted to move air through the box;
at least one heating element adapted to warm the air moving through the box;
at least one drying rack positioned inside the box for holding the instruments; and
an access into an interior of the box.

2. The box of claim 1, further comprising at least one filter positioned at an air inlet into the box.

3. The box of claim 1, further comprising a door hingeably attached to the box, the door providing the access into the interior of the box.

4. The box of claim 3, further comprising a magnetic door seal positioned about at least a portion of the access.

5. The box of claim 1, further comprising a push button to provide power to the at least one fan and the at least one heating element.

6. The box of claim 1, further comprising a drip pan positioned under the at least one drying rack.

7. The box of claim 6, further comprising drying pan racks to hold the at least one drying rack, wherein the drying rack has an open structure allowing liquids to fall of the instruments on the drying rack and into the drip pan.

8. A method for drying medical or dental instruments, the method comprising:
placing the instruments onto a drying rack in a box via an access into an interior of the box;
moving air through the box by one or more fans; and
heating the air moving through the box by one or more heating elements.

9. The method of claim 8, further comprising allowing the one or more fans to run for a predetermined period of time after the one or more heating elements turn off at an end of a drying cycle.

10. The method of claim 8, further comprising passing the air through one or more filters positioned at an air intake for the box.
